(19) United States
(12) Patent Application Publication
(10) Pub. No.: US 2008/0134508 A1
(43) Pub. Date: Jun. 12, 2008

(54) Method to Provide Slots in Pipes

(76) Inventor: Marcos Rogerio Pegoretti, Vitoria-Es (BR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/589,545

(22) PCT Filed: Jan. 11, 2005
(86) PCT No.: PCT/BR05/00005

§ 371 Date: Aug. 16, 2006

(30) Foreign Application Priority Data
Feb. 20, 2004 (BR) PI 0400812-0

(51) Int. Cl. B23P 15/16

(52) U.S. Cl. 29/896.6

(57) ABSTRACT

The present invention refers to a method to provide slots in pipes and, more specifically, to a method to provide slots in metal pipes used to extract oil or to form slotted lines, wherein said slots are specially designed to avoid the intake of impurities while pumping oil. More specifically, the method consists of the following steps: a) external cleaning of the pipe (1) with slag jetting to remove the protecting layer that comes from its manufacture or to remove the impurities due to its oxidation; b) placing the pipe (1) on the receiving table by the set of motors (2) to be subsequently transferred to the cutting table (3), by means of motors (4); c) positioning and fixation of the pipe in the cutting cabin (5) by screwing the pneumatic rotating plate (6); d) execution of the first sequence of slots in the pipe by means of laser or plasma, in a refrigerated environment, by making a first slot with pre-defined power and subsequently the opening of the slot with determined length and thickness, according to the characteristics of the pipe, with said slot having an initial section with parallel shape and subsequently with divergent section; e) angle rotation of the pipe by means of turning the rotating plate (6) to make the second sequence of slots, in the opposite direction of the first sequence and then successively on the whole perimeter of the pipe to meet the desired specification; f) removal of the sludge and impurities generated by the cut by the sleeves (7); g) internal cleaning of the slotted pipe with slag jetting; h) visual inspection of the slotted pipe to correct failures and possible imperfections with MIG soldering; and i) painting to provide a uniform visual aspect to the slotted pipe.

### FIELD OF THE INVENTION

The invention refers to a method to provide slots in pipes and, more specifically, to a method to provide slots in metal pipes used to extract oil or to form slotted lines, wherein said slots are specially designed to avoid the intake of impurities while pumping oil.

### BACKGROUND OF INVENTION

The oil industry uses a wide range of accessories, devices and equipment to perforate and extract oil, which are particularly important when dealing with perforations under water and in horizontal and vertical land wells.

One of such devices is a pipe provided with perforations, usually called slotted line or slotted pipe, which is used to extract oil from horizontal and vertical wells. The pipe has in its design, a number of slots to allow the oil to pass through them, blocking the passage of particulate material found in the well or in the oil region to be exploited.

Such pipes have various configurations. Some of them are made of wire systems, such as U.S. Pat. No. 4,550,778 and U.S. Pat. No. 4,821,800, which present the inconveniences of complex manufacturing; difficult introduction in the well (in horizontal wells, high flexibility rate is required); low mechanical resistance (screened pipes disrupt due to the low resistance of screens in complex route slotted wells, such as horizontal wells and those with high slope and angle). On the other hand, the existing slotted systems, such as U.S. Pat. No. 4,526,230, have the inconveniences of disruption of external pipes and consequent loss of sand that acts as the filtering element, the increase in the concentration of impurities in the filtering element and the loss of efficiency during its working life.

One of the solutions found was the use of a filtering element by means of making slots in the steel pipe used to take the oil out, therefore having, besides the easy acquisition of a filtering element, the advantages of high flexibility of the material and its mechanical resistance during the oil extraction process, i.e. the filtering element keeps the same mechanical characteristics of the whole oil extraction line. The embodiment of these filtering elements occurs by means of slots made by tools such as grindstones, circular band saws or plasma beams.

Examples of machines and tools to open cuttings, slots and perforations are disclosed in the U.S. Pat. No. 4,664,777 and U.S. Pat. No. 5,079,940. Such machines and tools are generally very complex mechanically speaking and require large energy costs.

Said machines/tools make perpendicular cuts on the pipe surface and with straight aspect, containing parallel walls and forming segmented slots along the length of the pipe. After some time, this configuration of walls causes slots to clog, since the particulate material settles there and no longer allows the oil to pass through.

To avoid clogging during its working life, another shape of slot was developed with divergent walls, smaller openings on the outer periphery of the pipe and bigger openings on its inside periphery. Said slots are made by conventional methods, such as with cutting discs and are randomly widened afterwards by means of side oscillation of the cutting disc itself. This new kind of slot, called calestone, has the inconvenience of increasing the opening of the periphery during the working life of the pipe, due to loss of wall thickness by abrasion of the sand passing through the slot. Therefore, the pipe loses the internal slot dimension and consequently loses the granular control of the sand.

A solution attempt is disclosed in U.S. Pat. No. 5,095,990, proposing slots that have on the outer part of the pipe a widened region over the initial slot to allow filtering elements to be fitted. This solution is made by means of molding, making the operation extremely costly, making the pipe structurally fragile and making its transportation difficult, besides the granular control problem previously mentioned.

An attempt to improve the configuration of the slot in the pipe wall was made by the Brazilian application PI 0202468-3 by this applicant, using a laser beam to make such cuts and guarantee that the walls are as smooth as possible, thus avoiding slot clogging. This method has the inconvenience of the use of a laser beam, whose focal distance is zero, and this way creates a parallel slot with a single width, which is the minimum laser width, i.e. 0.1 mm.

### SUMMARY OF THE INVENTION

One object of the present invention is to build pipes with slots that have a mixed transverse section, composed of a portion of parallel walls and a portion of divergent walls, continuously, to avoid clogging by particulate material.

It is also an object of the invention to make such slots by means of one single tool to guarantee that the walls are as smooth as possible to avoid the accumulation of particulate material.

These objects and other advantages are reached by means of a method to provide slots in pipes by using laser or plasma cutting equipment which assure that slots have the desired finish and configuration, by means of simple and fast operations, providing more uniformity and, at the same time, guaranteeing the structural resistance of the metal pipe.

### BRIEF DESCRIPTION OF THE DRAWINGS

The invention will be better understood in the light of the attached figures, given as mere examples, but without limitation, schematically representing:

FIG. 1—view of the pipe cutting and cooling assembly;

FIG. 2—P-P cut indicated in FIG. 1;

FIG. 3—detail W indicated in FIG. 1, showing the sequence and direction of the slots in the pipe;

FIG. 4—simplified view of the pipe cutting and displacement assembly;

FIG. 5—widened view in cross cut of the pipe, indicating the section of the slot; and

FIG. 6—cross cut view to indicate the sequence to make slots in the pipe.

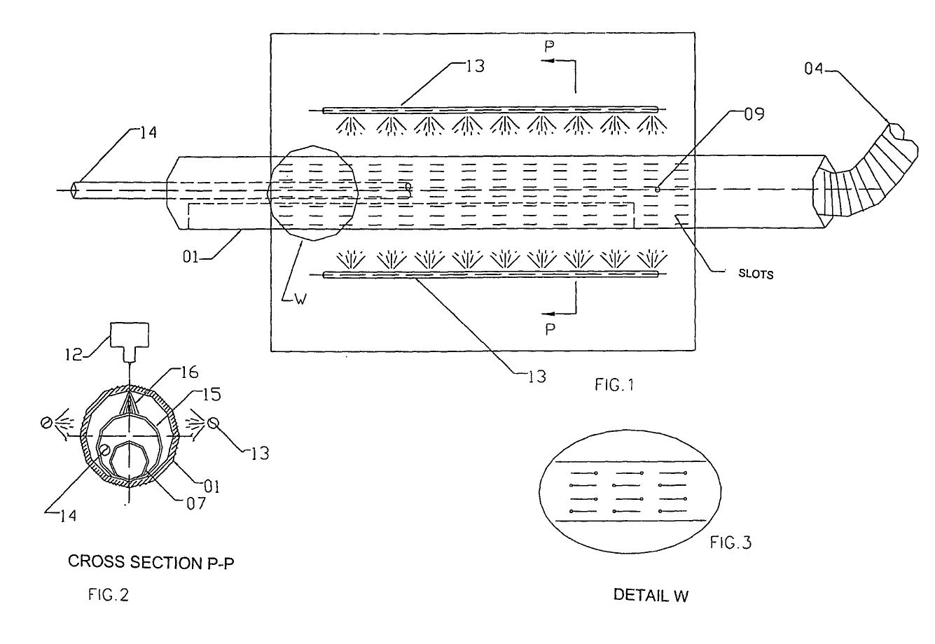

### DESCRIPTION OF THE PREFERRED EMBODIMENT

The method to provide slots in pipes, object of the present invention, consists of the following steps:

a) external cleaning of the pipe 1 with slag blasting to remove the protecting layer that comes from its manufacture or to remove the impurities due to its oxidation;
b) placing the pipe 1 on the receiving table by the set of motors 2 to be subsequently transferred to the cutting table 3, by means of motors 4;
c) positioning and fixation of the pipe in the cutting cabin 5 by tightening of the pneumatic rotating plate 6;
d) execution of the first sequence of slots in the pipe by laser or plasma, in a refrigerated environment, by making an initial hole with pre-defined power and subsequently opening the slot with determined length and thickness, according to the characteristics of the pipe, said slot having an initial parallel section and subsequently a divergent section;
e) angle rotation of the pipe by turning the rotating plate 6 to make the second sequence of slots, in the opposite direction to the first sequence and then successively on the whole perimeter of the pipe to meet the desired specification;
f) removal of the sludge and impurities generated by the cut by sleeves 7;
g) internal cleaning of the slotted pipe with slag jetting;
h) visual inspection of the slotted pipe to correct failures and possible imperfections with MIG soldering; and
i) painting to provide a uniform visual aspect of the slotted pipe.

The initial cleaning step is to make the pipe 1 free from impurities, protecting layers, oil and any other elements that may interfere with correct laser operation.

More specifically, the process starts by means of copper slag blasting to remove the protecting layer that comes from the manufacture of the pipe 1 or when it shows oxidation. After the pipe 1 is free from external impurities, it is stored in racks parallel to the receiving table (not shown). The pipe is transported from the racks to the receiving table by the motors 2.

Once the pipe 1 is on the receiving table, it is moved to the cutting table 3 by the motors 4, which move the pipe to the cutting position inside the cutting cabin 5. With the pipe in the cutting position, an electronic command activates the rotating plate 6, that fixes the pipe to it and the laser cutting process starts to provide the slots.

After the pipe 1 is positioned, the laser cutting process starts. An initial slot 8 is made with pre-defined power and subsequently the slot 9 of the continuous section is opened, with length and thickness determined according to the characteristics of the required project.

The programming of the openings of the continuous section 9 along the pipe 1 is made according to the profile presented in FIG. 5, constituted by an initial parallel section 10 and in continuity to a divergent section 11, being that the dimension and thickness of the slot 9 opening follow the specifications of each kind of project. Cutting standards allowing to control the dimensions of height A of the parallel section 10; angular opening B of the divergent section 11 and width D of the parallel section are respectively:
laser power—0 to 4000 watts
cutting speed—0 to 3000 mm/min
focal distance C from the laser source 12 (−1° to +10 mm)

The shape of the slot 9 is a result of these standards. From the focal distance C (FIG. 5) at zero, we have a cut where angle B will be zero, the width D will be 0.1 mm and the height A of the parallel section 10 will be equal to the pipe thickness.

Increasing the focal distance C angle B values start to increase the width D, which may reach up to 1.5 mm, at the same time the height A decreases up to the minimum value of ⅔ of the total thickness of the pipe 1, required to guarantee the structural integrity of the pipe after opening the slots 9.

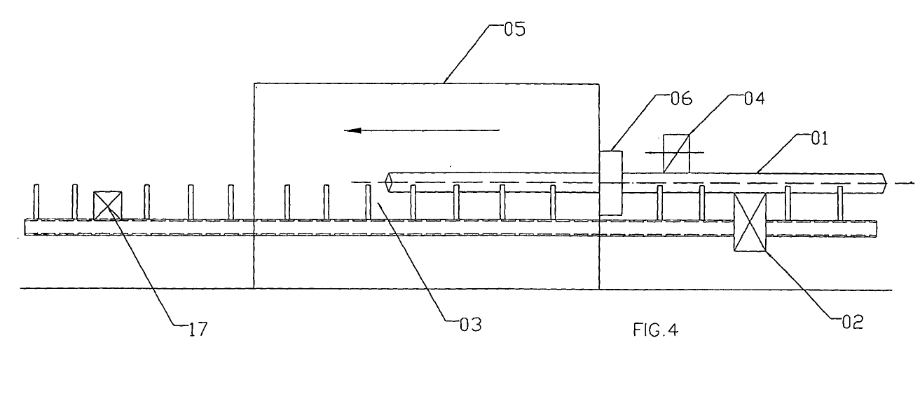

Configurations of slots 9 are placed on the periphery of the pipe 1, as per FIG. 3 in its detail W, with initial holes 8 to open alternate slots 9 to guarantee more resistance to the pipe.

Slots 9 are made lengthwise to the pipe from a point 0 (zero) up to a given point and returning from this point to the initial point, continuously but inversely opening the slot, guaranteeing more resistance to the slotted pipes.

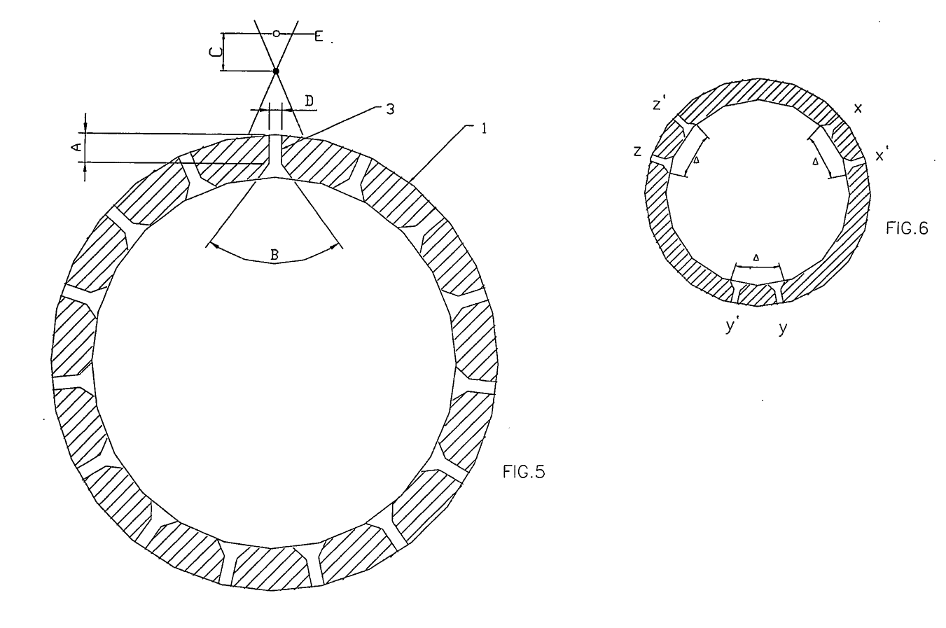

As it can be seen in FIG. 6, after slot X of the first line is made, the pneumatic plate 6 turns the pipe 1 120° to make slot Y and subsequently more 120° to make slot Z. Subsequently, the pipe 1 returns to the initial position added by a delta value, with the fourth line becoming parallel to the first line and then successively, until all required slots are made.

The laser cutting process produces a lot of heat in the pipe 1 and its cooling is therefore required. Such cooling is made on its external surface by means of refrigerated air which is sprayed by systems of pipes with holes 13, parallel to its length, and it is internally cooled by means of compressed air 14.

During the process, sludge material is created, and it is sucked by a sleeve 7 and taken to a filter (not shown in FIG. 4). This filter is periodically cleaned to take out sludge. A free pipe 15 with a smaller diameter is simultaneously introduced inside the pipe 1 to be slotted, to protect the opposite wall on which the laser is making the slots 9. This way, when the slots are made, the laser beam 16 coming from the laser source 12 does not affect the internal finish of the pipe walls 1 to be manufactured.

In many cases, the pipe 1 is longer than the length of the cutting cabin 5 and therefore slots are made in modules. Taking as an example a 12-meter pipe and a 3-meter cutting cabin, the first series of slots is made and then the moving system 4 moves the pipe 1, presenting a new section to be cut and then successively until all slots 9 are made in the pipe 1.

At the end of the process, the pipe 1 is mechanically taken from the cutting table, by means of the existing motors 17, goes through an inspection process for possible anomalies generated by structural and surface finish characteristics of the pipe.

After anomalies are verified, they are corrected by means of MIG soldering and the pipe 1 is sanded, internally cleaned by means of copper drag jetting and externally painted, to guarantee that the pipe does not oxidize on the periphery of the slots and to keep the uniformity of its visual aspect.

The final result is a pipe with precise slots, with divergent and parallel continuous section slots, which prevent the pipe from clogging while in use and a pipe that has high structural resistance, thanks to the characteristics of the method to make the slots.

Alternatively, the laser cutting equipment may be substituted by plasma cutting equipment.

Among the numerous advantages of the invention, the following are highlighted:
uniformity of slots;
serving different kinds of projects;
cutting section format with a parallel portion allowing to control sand grains and avoiding the loss of control by abrasion and a divergent portion to reduce the parallel section and serve as escape for sand and consequently less clogging of slots during working life, prolonging it;
size control of the dimensions A and D by means of the previously mentioned cutting control standards; and
application in wells that require very fine grain control (0.1 mm diameter).

1. Method to provide slots in pipes that comprises the following steps:
a) external cleaning of the pipe (1) with slag blasting to remove the protecting layer that comes from its manufacture or to remove the impurities due to its oxidation;
b) placing the pipe (1) on the receiving table by the set of motors (2) to be subsequently transferred to the cutting table (3), by means of motors (4);
c) positioning and fixation of the pipe in the cutting cabin (5) by tightening of the pneumatic rotating plate (6);
d) execution of the first sequence of slots in the pipe by laser or plasma, in a refrigerated environment, by making an initial hole with pre-defined power and subsequently opening the slot with determined length and thickness, according to the characteristics of the pipe, said slot having an initial parallel section and subsequently a divergent section;
e) angle rotation of the pipe by turning the rotating plate (6) to make the second sequence of slots, in the opposite direction of the first sequence and then successively on the whole perimeter of the pipe to meet the desired specification;
f) removal of the sludge and impurities generated by the cut by sleeves (7);
g) internal cleaning of the slotted pipe with slag jetting;
h) visual inspection of the slotted pipe to correct failures and possible imperfections with MIG soldering; and
i) painting to provide a uniform visual aspect of the slotted pipe.

2. Method according to claim 1, wherein the slots have a mixed continuous section composed of a parallel section and subsequently a divergent section, being said slots made by laser and having as its measurements the height (A) of the parallel section (10), the angle opening (B) of the divergent section (11) and the width (D) of the parallel section (10) due to the focal distance (C), in which the angle (B) of the divergent section (11) varies between zero and 90°, the height (D) of the parallel section (10) varies between 0.1 mm and 1.5 mm and the height (A) of the parallel section (10) varies between the thickness of the pipe and ⅔ of the total thickness of the pipe.

3. Method according to claim 1, made in a piece of equipment comprising a cutting table (3) with movement motors (4, 2, 17), a rotating and retention plate (6) of the pipe (1) with a cooling system by means of perforated pipe systems (13) parallel to the extension of the pipe (1) and with a protection pipe (15) with a flexible cleaning sleeve (7) and laser source (12).

4. Method according to claim 1, where slots are optionally made by means of plasma cutting equipment.
